(19) United States
(12) Patent Application Publication
(10) Pub. No.: US 2023/0368242 A1
(43) Pub. Date: Nov. 16, 2023

(54) INFORMATION PROCESSING DEVICE, INFORMATION PROCESSING METHOD, AND RECORDING MEDIUM

(71) Applicant: M.D.B Corporation, Tokyo (JP)

(72) Inventors: Kenji FUKUDA, Tokyo (JP); Naoki Sawada, Tokyo (JP); Yuri Satou, Tokyo (JP)

(73) Assignee: M.D.B Corporation, Tokyo (JP)

(21) Appl. No.: 18/029,746

(22) PCT Filed: Oct. 9, 2020
(86) PCT No.: PCT/JP2020/038317

§ 371 Date: Mar. 31, 2023

(51) Int. Cl. G06Q 30/0251; H04W 4/12

(52) U.S. Cl. CPC G06Q 30/0252; H04W 4/12

(57) ABSTRACT

The information processing device includes an information acquisition means, an estimation means and a messaging means. The information acquisition means acquires information related to a target animal. The estimation means estimates an event related to the target animal based on the acquired information. The messaging means transmits message information based on at least one of the event and relevance when the estimated event related to the target animal has the relevance.

### TECHNICAL FIELD

The present invention relates to a technique for transmitting messages related to an animal.

### BACKGROUND ART

There is a demand that pet owners want to grasp the state and behavior of pets in their home during their work and when they are is leaving home. Patent Document 1 describes a system in which a condition of a pet is detected by a sensor terminal, utterance data of a first person is generated on the basis of detection data, and conversation with the owner or other user is performed using an interactive SNS.

### PRECEDING TECHNICAL REFERENCES

### Patent Document

Patent Document 1: International Publication WO2016/125478

### SUMMARY

### Problem to be Solved by the Invention

However, Patent Document 1 only realizes a conversation by individually generating the speaking data of each animal based on the emotion and behavior of each animal.

One object of the present invention is to provide an information processing device capable of transmitting message information and additional information based on the relevance of events related to animals.

### Means for Solving the Problem

According to an example aspect of the present invention, there is provided an information processing device comprising:
an information acquisition means configured to acquire information related to a target animal;
an estimation means configured to estimate an event related to the target animal based on the acquired information; and
a messaging means configured to transmit message information based on at least one of the event and relevance when the estimated event related to the target animal has the relevance.

According to another example aspect of the present invention, there is provided an information processing method comprising:
acquiring information related to a target animal;
estimating an event related to the target animal based on the acquired information; and
transmitting message information based on at least one of the event and relevance when the estimated event related to the target animal has the relevance.

According to still another example aspect of the present invention, there is provided a recording medium recording a program, the program causing a computer to execute processing comprising:
acquiring information related to a target animal;
estimating an event related to the target animal based on the acquired information; and
transmitting message information based on at least one of the event and relevance when the estimated event related to the target animal has the relevance.

### BRIEF DESCRIPTION OF THE DRAWINGS

FIG. 1 shows an overall configuration of a communication system to which an information processing device is applied.

FIG. 2 shows an example of a floor plan of a home of an owner.

FIG. 3 is a block diagram showing a configuration of a home system.

FIG. 4 is a block diagram showing a configuration of a pet terminal.

FIGS. 5A and 5B are a block diagrams showing configurations of a server and a user terminal.

FIG. 6 is a flowchart of information transmission processing.

FIG. 7 is an example of displaying images transmitted by the information transmission processing.

FIG. 8 is a block diagram showing a functional configuration of the information processing device of a second example embodiment.

FIG. 9 is a flowchart of processing by the information processing device of the second example embodiment.

### EXAMPLE EMBODIMENTS

### First Example Embodiment

[Overall Configuration]

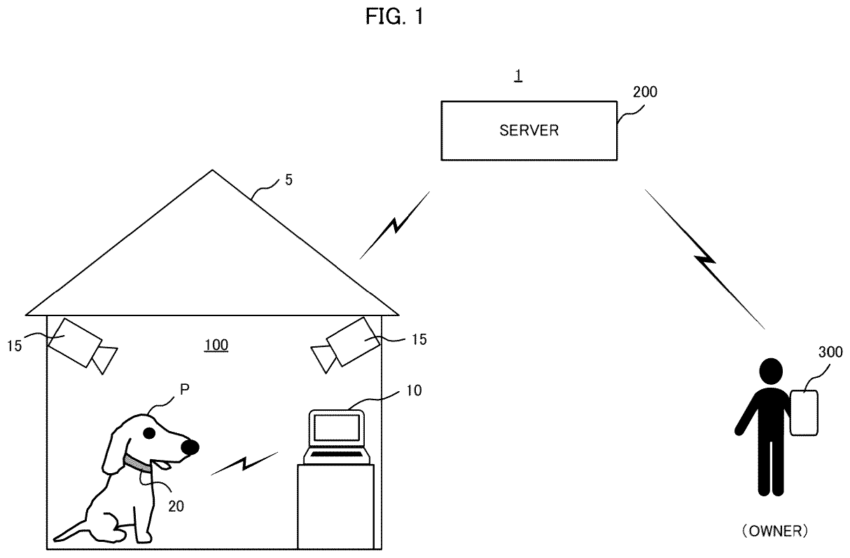

FIG. 1 shows an overall configuration of a communication system to which an information processing device according to the present invention is applied. The communication system 1 includes a home system 100 installed in the home 5 of the owner of the pet, a server 200, and a user terminal 300 used by the owner. The pet P is staying at the home 5 of the owner, and a pet terminal 20 is attached to the pet P. Further, fixed cameras 15 are installed in predetermined locations in the home 5. The home system 100 and the server 200 can communicate by wired or wireless communication. The server 200 can also communicate wirelessly with the user terminal 300 of the owner.

As a basic operation, the home system 100 generates message information about the pet P based on the location, behavior and state of the pet P (hereinafter referred to as the “state of the pet P”), and transmits the message information to the user terminal 300 of the owner via an interactive SNS (Social Network Service). Here, the message information includes a text message, a stamp, an image and the like. When the state of the pet P satisfies a predetermined condition (hereinafter referred to as the “transmission condition”), the server 200 transmits the message information, such as a text message, a stamp and/or an image prepared beforehand or generated in correspondence with the transmission condition, to the user terminal 300 of the owner using the interactive SNS. Thus, the owner can receive the message information according to the state of the pet P and grasp the state of the pet.

The server 200 transmits the message information of appropriate contents to the owner's user terminal 300 at appropriate timing based on the state of the pet P. Specifically, when the state of the pet P satisfies a predetermined transmission condition, the server 200 transmits the message information representing the state of the pet P at that time to the user terminal 300 of the owner via an interactive SNS. The owner can see the state of the pet P by viewing the message information transmitted to the user terminal 300.

The message information generated may be based on the behavior, location, and state of Pet P. The trigger for transmitting the message information is not limited. For example, the message information may be transmitted based on the request of the owner. It is also possible to perform interactive conversation such that the owner sends the image or message to the pet P and the pet P returns the image or message or stamp to the owner. For example, when the owner sends the message “Did you have a meal?”, the Pet P returns the image of the rice and the stamp.

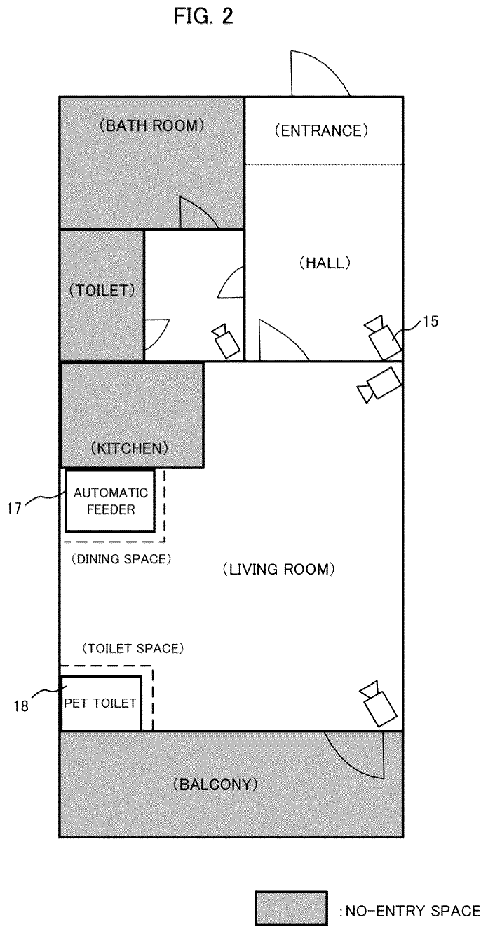

FIG. 2 shows an example of a floor plan of the owner's home 5. The home has an entrance, hall, bathroom, toilet, living room, kitchen, balcony, etc. The door partitioning each space is basically open, and the pet can move each space freely. In each space, a fixed camera 15 for capturing the state of the pet P is installed. Some of the spaces in the home 5 are decided to be the spaces where the pet P should not enter (hereinafter referred to as “no-entry spaces”). The no-entry spaces include a space to which the entry is not allowed because it is dangerous for the pet P, and a space to which the entry is not allowed because the pet P may do mischief. In the example of FIG. 2, the bathroom, toilet, kitchen, and balcony shown in gray color are determined as the no-entry spaces.

[Home System]

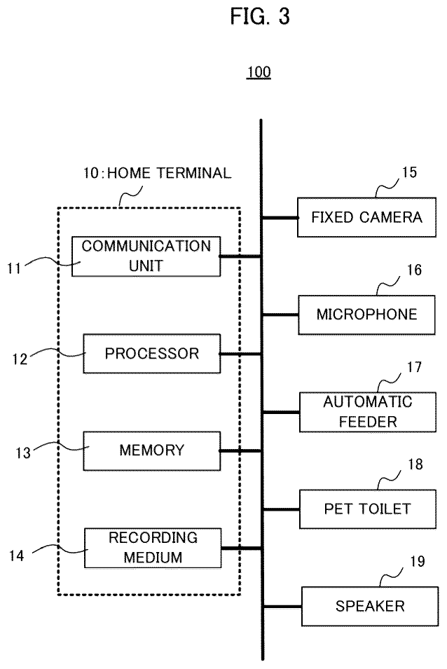

FIG. 3 is a block diagram showing the configuration of the home system 100 installed in the home 5. In the example of FIG. 3, the home system 100 includes a home terminal 10, fixed cameras 15, a microphone 16, an automatic feeder 17, a pet toilet 18, and a speaker 19. However, the home system 100 may include, not all of the above-described elements, but some of them. The home terminal 10 is, for example, a terminal device such as a PC, a tablet, or a smartphone, and includes a communication unit 11, a processor 12, a memory 13, and a recording medium 14.

The communication unit 11 communicates with an external device. Specifically, the communication unit 11 wirelessly communicates with the pet terminal 20 attached to the pet P by Bluetooth (registered trademark), for example. The communication unit 11 communicates with the server 200 in a wired or wireless manner.

The processor 12 is a computer such as a CPU (Central Processing Unit) and controls the entire home terminal 10 by executing a program prepared in advance. The processor 12 may be a GPU (Graphics Processing Unit), a FPGA (Field-Programmable Gate Array), a DSP (Demand-Side Platform), an ASIC (Application Specific Integrated Circuit), or the like. The processor 12 executes image transmission processing described later by executing a program prepared in advance. Also, the processor 12 receives the message information that the owner transmitted from the user terminal 300.

The memory 13 may be a ROM (Read Only Memory) and a RAM (Random Access Memory). The memory 13 stores various programs executed by the processor 12. The memory 13 is also used as a working memory during various processes performed by the processor 12.

The recording medium 14 is a non-volatile and non-transitory recording medium such as a disk-like recording medium and a semiconductor memory, and is configured to be detachable from the home terminal 10. The recording medium 14 records various programs executed by the processor 12. When the home terminal 10 transmits information and images related to the pet P to the server 200, the program recorded on the recording medium 14 is loaded into the memory 13 and executed by the processor 12. The images captured by the fixed cameras 15, the sound collected by the microphone 16, information received from the pet terminal 20, and the like are temporarily stored in the memory 13.

The fixed cameras 15 are installed at predetermined positions in the home 5. Basically, the necessary number of fixed cameras 15 are installed so as to cover the entire spaces in which the pet P can move. In particular, the fixed cameras 15 are installed at the positions to shoot the images of the areas including the no-entry spaces of the pet P. The fixed cameras 15 are always operating to shoot a video of the shooting range, and transmit the video the home terminal 10.

The microphone 16 is installed in each space of the home 5. The microphone 16 may be integrated with the fixed camera 15. The microphone 16 collects the sound generated in each space, and transmits the sound to the home terminal 10. The home terminal 10 transmits the sound collected by the microphone 16 to the server 200.

The automatic feeder 17 is provided in the dining space in the living room as shown in FIG. 2. The automatic feeder 17 is a device to feed the pet P when the owner is absent. For example, the automatic feeder 17 automatically supplies the feed to the dish for pet at a time set in advance, and transmits a notice indicating that the feed was given to the pet P to the home terminal 10. The home terminal 10 transmits the notice from the automatic feeder 17 to the server 200. The home terminal 10 also transmits, to the server 200, the image captured by the fixed camera around the time of receiving the notice.

The pet toilet 18 is installed in the toilet space in the living room as shown in FIG. 2. The pet toilet 18 includes, for example, a water absorbing sheet and a sensor, detects excretion of the pet P, and sends a notice to the home terminal 10. The home terminal 10 transmits the notice from the pet toilet 18 to the server 200. The home terminal 10 also transmits, to the server 200, the image captured by the fixed camera 15 around the time of receiving the notice.

The speaker 19 is installed in the living room or the no-entry space of the home 5, and outputs a warning sound and a message for the pet P. For example, by recording a scolding voice of the owner (“Don't enter there!”) in advance, the same voice can be outputted to the pet when the pet P enters the no-entry space, even when the owner is not present.

[Pet Terminal]

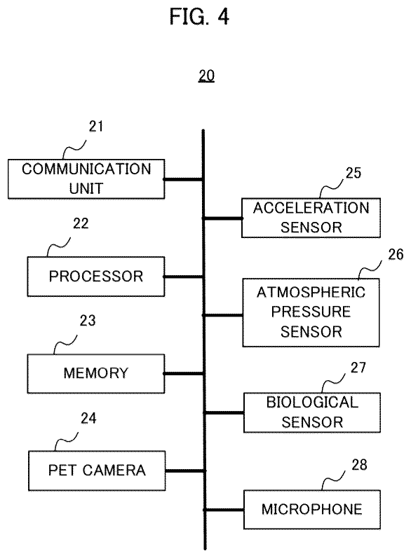

FIG. 4 is a block diagram showing the configuration of the pet terminal 20 attached to the pet P. The pet terminal 20 may be attached to the pet instead of the collar of the pet P or attached to the collar that the pet is wearing, for example. The pet terminal 20 includes a communication unit 21, a processor 22, a memory 23, a pet camera 24, an acceleration sensor 25, an atmospheric pressure sensor 26, a biological sensor 27, and a microphone 28.

The communication unit 21 communicates with an external device. Specifically, the communication unit 21 wirelessly communicates with the home terminal 10 by Bluetooth (registered trademark), for example.

The processor 22 is a computer, such as a CPU, that controls the entire pet terminal 20 by executing a predetermined program. The processor 12 periodically transmits the information acquired by each sensor to the home terminal 10 by executing a program prepared in advance.

The memory 23 is configured by a ROM, RAM or the like. The memory 23 stores various programs executed by the processor 22. The memory 23 is also used as a working memory during various processes executed by the processor 22. Furthermore, the memory 23 temporarily stores information detected by each sensor.

The pet camera 24 is a camera for shooting the image of the pet′ view. The pet camera 24 may be configured to detect the orientation of the neck of the pet P to determine the shooting direction, may be mounted near the head of the pet P, or may be a camera that shoots the front of the pet P at a wide angle. The pet camera 24 shoots an area including the viewing direction of the pet P and transmits the shot image to the home terminal 10. Thus, the home terminal 10 can acquire the image of the pet's view.

The acceleration sensor 25 is a three-axis acceleration sensor, which measures the motion of the pet P in the three-axis direction and transmits it to the home terminal 10. Based on the output of the acceleration sensor 25, the home terminal 10 can estimate the activity amount of the pet P or the like. The atmospheric pressure sensor 26 measures the atmospheric pressure at the place of the pet P and transmits it to the home terminal 10. Based on the output of the atmospheric pressure sensor 26, the home terminal 10 can detect the vertical movement of the pet P, e.g., a jump. Further, although not shown in FIG. 4, a gyro sensor may be used. A six-axis sensor in which a three-axis acceleration sensor and a three-axis gyro sensor (a three-axis angular velocity sensor) are integrated may be used. The sensor is not limited to the above-described one as long as the sensor can measure the activity amount of the animal.

The biological sensor 27 is a sensor for measuring the biological information of the pet P. For example, the biological sensor 27 measures the body temperature, the heart rate and the respiration rate of the pet P, and transmits them to the home terminal 10. The home terminal 10 transmits the acquired biological information to the server 200.

The microphone 28 collects the sound around the pet P and transmits the sound to the home terminal 10. The home terminal 10 transmits the collected sound to the server 200. The server 200 can estimate the state of the pet, e.g., the pet P is crying or barking, based on the received sound. The server 200 can estimate the motion state, the mental state, or the like of the pet based on the sound of the pet P running around or the breath sound, for example.

[Server]

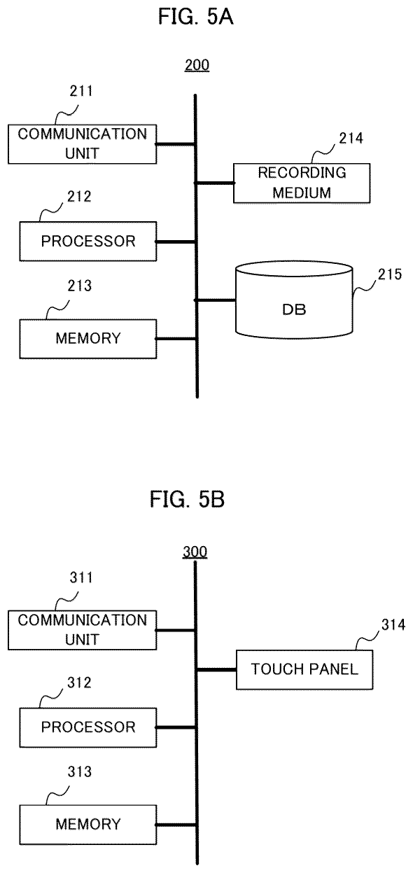

FIG. 5A is a block diagram illustrating the configuration of the server 200. The server 200 transmits messages to and receives messages from the user terminal 300 by the interactive SNS. The server 200 includes a communication unit 211, a processor 212, a memory 213, a recording medium 214, and a database 215.

The communication unit 211 transmits and receives data to and from an external device. Specifically, the communication unit 211 transmits and receives information to and from the home terminal 10 and the user terminal 300 of the owner.

The processor 212 is a computer, such as a CPU, that controls the entire server 200 by executing a program prepared in advance. The processor 212 may be a GPU, a FPGA, a DSP, an ASIC or the like. Specifically, the processor 212 transmits message information to the owner's user terminal 300 by the interactive SNS.

The memory 213 is configured by a ROM, RAM, or the like. The memory 213 is also used as a working memory during various processes by the processor 212. The recording medium 214 is a non-volatile and non-transitory recording medium such as a disk-like recording medium or a semiconductor memory and is configured to be detachable from the server 200. The recording medium 214 records various programs executed by the processor 212.

The database 215 stores information and images received from the home terminal 10 through the communication unit 211. That is, message information and images transmitted and received by users of a plurality of terminals including the home terminal 10 and the user terminals 300 are stored in the database 215. Further, the database 215 stores, for each user, the transmission condition of the message information, and the message information prepared in advance for each transmission condition (e.g., a predetermined message, stamp, etc.). The server 200 may include a keyboard, an input unit such as a mouse, and a display unit such as a liquid crystal display to allow an administrator to give instructions or input.

[User Terminal]

FIG. 5B is a block diagram illustrating an internal configuration of the user terminal 300 used by the owner. The user terminal 300 is, for example, a smartphone, a tablet, a PC, or the like. The user terminal 300 includes a communication unit 311, a processor 312, a memory 313, and a touch panel 314.

The communication unit 311 transmits and receives data to and from the external device. Specifically, the communication unit 311 transmits and receives information to and from the server 200.

The processor 312 is a computer, such as a CPU, and controls the entire user terminal 300 by executing a program prepared in advance. The processor 312 may be a GPU, a FPGA, a DSP, an ASIC or the like. Specifically, the user terminal 300 is installed with a messaging application for the interactive SNS executed by the server 200. The “messaging application” is an application that provides exchange of information such as text messages, stamps, and images. The processor 312 receives the transmitted message information and images through the server 200 by the messaging application and displays them on the touch panel 314. The processor 312 also transmits the message information entered by the owner to the server 200 through the messaging application.

The memory 313 is configured by a ROM and a RAM. The memory 313 is also used as a working memory during various processing by the processor 312. The touch panel 314 displays the message information received by the user terminal 300. The touch panel 314 also functions as an input device of a user.

[Transmit Message Information]

In the present example embodiment, the server 200 generates message information based on the relevance of the events occurring for a plurality of pets and transmits the message information to the user terminal 300 of the owner. Here, the term “event” is a concept that includes an action and a behavior of the pet itself and a phenomenon that occurs in association with the pet. In addition, the term “relevance” includes the fact that the events related to a plurality of pets are matched or similar, the fact that the events related to a plurality of pets become a predetermined relationship, and the like.

Examples of the event related to the pet are as follows:
(1) Action and behavior of the pets themselves
The pet sleeps, rises, jumps, barks, cries, eats, urinates, defecates, etc.
(2) Event associated with the owner
Snuggling to the owner, running away from the owner, getting scolded by the owner, getting praised by the owner, etc.
(3) Events about relationships with other pets in the house
Getting along with other pets, getting a fight with other pets, doing something together with other pets, and so on.

In the following description, it is assumed that a certain owner A owns a pet Pa and another owner B owns a pet Pb. In addition, it is assumed that the owners A and B are registered with an interactive SNS operated by the server 200 as friends, and have made the setting to the server 200 so that they can exchange the message information related to their pets.

The server 200 periodically receives various information about the pet Pa and Pb from the home terminals 10 of the owners A and B, respectively. If the server 200 determines that the events of the pets Pa and Pb have a predetermined relevance, the server 200 transmits the messaging information to the user terminals 300 of the owners A and B. Hereinafter, an example in which the events related to the pets has the relevance will be described.

(1) Occurring the Same Event Substantially at the Same Time

One example of a case where the events related to the pets have relevance is that the same events related to multiple pets occurred substantially at the same time. Note that “substantially at the same time” includes not only the case in which those events occur strictly at the same time but also the case in which they occur within a predetermined time interval (for example, about 2 to 3 minutes) based on the processing time or the like in the server 200. Specifically, when the pets Pa and Pb perform the same action substantially at the same time, the server 200 transmits the message information including the words indicating the matched event such as “synchronous,” “together,” and “at the same time,” to the user terminals 300 of the owners A and B. For example, if the pets Pa and Pb urinate substantially at the same time, the server 200 transmits the messaging information such as “Peeing, synchronous!” to the user terminals 300 of the owners A and B.

The birthday of the pet may be an event related to the pet. If the birthday of the pet Pa matches the birthday of the pet Pb, the server 200 may transmit the messages information such as “Birthday, synchronous!” on that birthday. Also, when the types of the pets are the same (e.g., dogs of the same type), or when their trimming salons or the hospitals are the same, the server 200 may transmit the message information including words such as “synchronous”, “same”, or the like as the events relating to the pets are matched.

When the events of the pets Pa and Pb match, only the words such as “synchronous!” indicating that the event matches, or “synchronous again!” indicating that the event matches repeatedly may be sent as the message information, regardless of what the event is. As described above, by including the words indicating the coincidence of the events in the message information, the owners A and B can have a sense of affinity with their own pet and the partner's pet and enjoy the conversation more.

As described above, when the same event occurs at the same time or within a predetermined period of time, the server 200 may regard it as the relevance of the events related to a plurality of pets Pa and Pb and transmit the message information based on the relevance.

(2) Order of Events Matches

If the events for the multiple pets registered as friends occur in the same order, the server 200 may transmit the message information including the words such as “synchronous”, “same”, etc. For example, when the pets Pa and Pb have played using several toys in the same order, the server 200 may transmit the message information such as “toy, synchronous!”.

As described above, when the events occur in the same order, the server 200 may regard it as the relevance of the events for the plurality of pets Pa and Pb and transmit the message information based on the relevance.

(3) Occurring the Same Event in Such a Manner that One Follows Another in Time

When the events related to the pets Pa and Pb match with each other in such a manner that one follows another in time, the server 200 may transmit the message information taking into account the anteroposterior relation. For example, when the pet Pa went to bed first at night and then the pet Pb went to bed, the server 200 may transmit the message information such as “Good night before you” as the utterance of the pet Pa to the user terminals 300 of the owners A and B, and then transmit the message information such as “Good night, me too.” as the utterance of the pet Pb to the user terminals 300 of the owners A and B.

In addition, when the pet Pa is scolded by the owner A and then the pet Pb is scolded by the owner B, the server 200 may transmit the message information such as “I'm scolded . . . ” as the utterance of the pet Pa, and then transmit the message information such as “I'm scolded, too . . . ” as the utterance of the pet Pb. In this way, by transmitting the message information related to the same event, the owners A and B can enjoy the conversation more because they have a sense of affinity with their pet and the partner's pet.

As described above, when the same events occur for a plurality of pets Pa and Pb at the same time or within a predetermined time, the server 200 may transmit the message information indicating that the events occurred simultaneously or synchronously.

(4) Contrastive Events Occur

The message information may be transmitted when the event related to one pet and the event related to another pet have an inverse, contrary, or contrastive relationship. For example, if the pet Pa was praised by the owner A, and then the pet Pb was scolded by the owner B, the server 200 may transmit the message information such as “I did! I was praised!” as the utterance of the pet Pa, and then transmit the message information such as “That's good. I was scolded . . . ” as the utterance of the pet Pb. Thus, by transmitting the message information related to the contrastive events, the owners A and B can enjoy the conversation more by giving a sense of affinity with their own pet and the partner's pet.

As described above, when the contrastive events occur, the server 200 may regard it as the relevance of the events related to the plurality of pet Pa and Pb and transmit the message information based on the contrastive events.

(5) One Pet Speaks about the Event of the Other Pet

The server 200 may transmit the message information of an utterance for a series of events related to one pet from another pet. For example, if the pet Pa is scolded and then praised by the owner A, the server 200 may transmit the message such as “You are praised. Good for you.” as the utterance of the pet Pb. In addition, if the pet Pa had a fight with other pet in the house and then made up, the server 200 may transmit the message information such as “I'm glad you made up.” as the utterance of the pet Pb. Further, if the birthday of the pet Pa is registered in advance, the server 200 may transmit the message information such as “Happy birthday!” to the pet Pa from the pet Pb on the birthday of the pet Pa.

As described above, when a particular event occurs to one of the plurality of pets Pa and Pb, the server 200 may transmit the message information including the utterance from one pet to the other pet.

In each of the above-described examples, the server 200 basically transmits the text message to the user terminal 300 of the owner. However, the server 200 may transmit a stamp corresponding to the contents of each message as the message information. In particular, the server 200 may transmit a rare stamp if the events related to the pets coincides accidentally. Also, the more matched the events of more pets, i.e., the higher the degree of chance, the rarer stamp may be transmitted. In this way, when the comment is transmitted to one pet by the other pets who have registered as friends, the owners can have a sense of affinity with their pet and the partner's pet, and enjoy the conversation more. In addition, the spirit of kindness to animals can be nurtured.

[Transmitting Advertising Information]

In the above example, the server 200 transmits the message information, such as text messages and stamps, based on the relevance of the events related to the pets. However, the server 200 may also transmit relevant additional information. Specifically, the server 200 may transmit advertising information of products or goods associated with the event related to the pet. For example, when the timing of the meals of the plurality of pets matches, the server 200 may transmit advertising information such as a pet food to the user terminal 300 of the owner. In addition, when the timing of the excretion of the plurality of pets matches, the server 200 may transmit advertising information of the toilet goods of the pets. Further, if the event related to the pet is an action such as the pet itself barking, acting violently, or the like, the server 200 may transmit advertising information such as a toy for the pet.

In addition to the advertising information, the server 200 may transmit point information or coupon information that can be used to purchase products or goods. In this case, the more pets the event matches, i.e., the more chance, the more points or higher discount rate coupons may be transmitted. For example, the server 200 may transmit a 20% discount coupon of a pet food if the meal timings of two pets match, and a 30% discount coupon of a pet food if the meal timings of the three pets match.

Further, the server 200 may transmit a goods list instead of a coupon or the like. In this case, the owner can obtain the desired goods included in the goods list or purchase them at a high discount rate. Further, the owner may register the desired product in advance in the server 200, so that the owner can obtain the registered desired product when the events of the pet match once or multiple times.

When transmitting additional information such as advertising information or coupons related to the products as described above, the server 200 may transmit the additional information by the name of a company or advertiser handling the products. Thus, since the information of the company or advertiser is also displayed on the owner's user terminal 300, the advertising effect of the company can be enhanced. In addition, instead of transmitting the additional information by the name of the company or advertiser, the additional information may be transmitted by the mascot or character name of the company or advertiser.

As described above, the server 200 may transmit the additional information including at least one of the advertising information, the discount information, and the presentation information of products associated with the event based on the event related to the target animal.

[Information Transmission Processing]

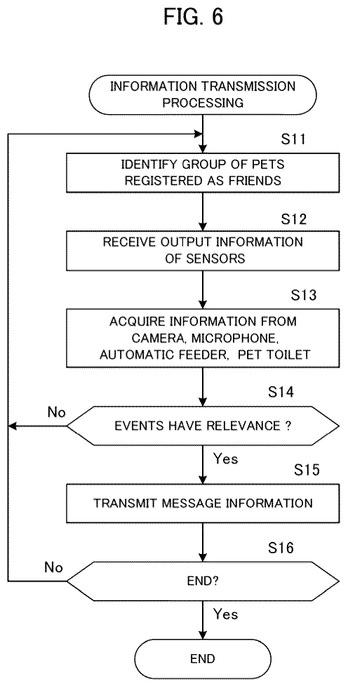

FIG. 6 is a flowchart illustrating information transmission processing executed by the server 200. This processing is realized by the processor 212 shown in FIG. 5 which executes a program prepared in advance.

First, the server 200 identifies a group of pets P that are mutually registered as friends based on the information of the owner (pet) registered in the server 200 (step S11). Next, the server 200 receives the output information of the sensors of the pet terminal 20 from each home terminal 10 for each pet P belonging to the group (step S12). Further, the server 200 acquires information obtained by the fixed camera 15, the microphone 16, the automated feeder 17, the pet toilet 18, and the like installed in the home 5 from the home terminal 10 for the respective pets P (step S13).

Next, the server 200 estimates the events related to the pets P based on the information acquired in steps S11 and S12, and determines whether or not the events related to the pets P have the specific relevance as exemplified above (step S14). If the events for the pets P do not have the specific relevance (step S14: No), the process returns to step S11. On the other hand, if the events for the pets P have the specific relevance (step S14: Yes), the server 200 transmits the message information including a word or the like indicating the relevance to the user terminals 300 (step S15). At this time, the server 200 may transmit advertising information, a product list, or the like of the products related to the event. Thus, the message information generated based on the relevance of the events related to the plurality of pets registered as friends is transmitted to the user terminals 300.

Next, the server 200 determines whether or not to end the information transmission processing (step S16). Normally, the owner operates the user terminal 300 to turn on the information transmission processing by the server 200 when he or she leaves home, and operates the user terminal 300 to turn off the information transmission processing when he or she comes back home. Therefore, the information transmission processing continues until the owner turns off the information transmission processing, and when the owner turns off the information transmission processing (step S15: Yes), the information transmission processing ends.

Incidentally, it is merely an example that the owner turns on the information transmission processing when he or she goes out and turns off when her or she returns home. Other than this, based on the position information of the user terminal 300, the information transmission processing may be turned on when it is determined that the owner is not in his/her home, and the information transmission processing may be turned off when it is determined that the owner is in his/her home. Further, the owner may manually switch on/off the information transmission processing by operating the user terminal 300.

[Examples of Message Information]

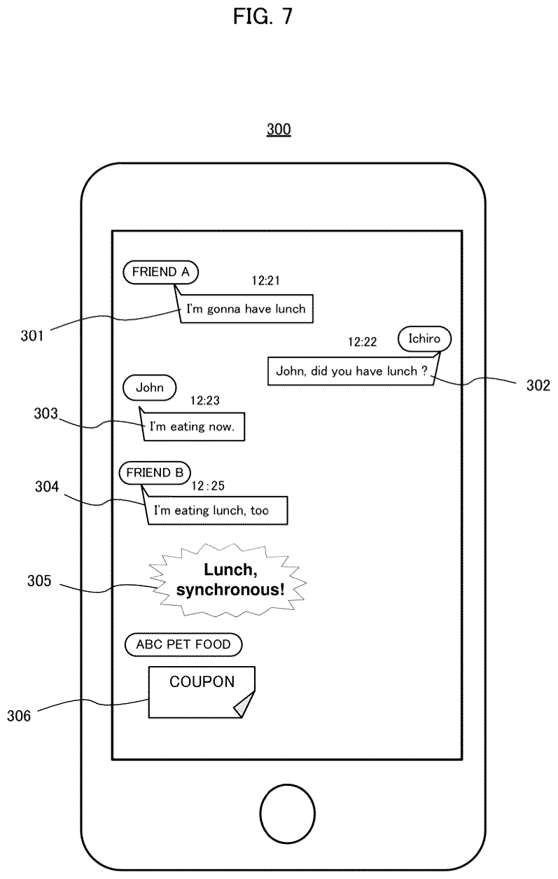

FIG. 7 shows a display example of the message information and the additional information transmitted by the information transmission processing. In this example, the user terminal 300 of the owner is displaying the message information and the additional information transmitted from the server 200 through the interactive SNS. It is assumed that the name of the owner is “Ichiro” and the name of the pet P is “John”. Also, it is assumed that the pets of other owners are registered as the friends A and B, and the messages from the friends A and B are also displayed.

Specifically, first of all, the message 301 of “I'm gonna have lunch” was received from the friend A, and the owner who saw it transmitted the message 302 saying “John, did you have lunch?” In response, John transmitted the message 303 saying “I'm eating now.” Then the friend B transmitted the message 304 saying “I'm eating lunch, too.” Therefore, the friends A and B, and John are eating lunch within the predetermined time, and there is a match of the events. As a result, the server 200 transmitted the message 305 of “Lunch synchronous!” and the coupon 306 by the company name “ABC PET FOOD”.

[Modification]

In the first example embodiment described above, basically the information acquired by various devices and the pet terminal 20 installed in the home 5 are transmitted to the server 200 as they are, and the server 200 performs a state analysis or the like to determine the state of the pet P on the basis of the information received. Instead, a part of the processing for determining the state of the pet P may be performed in the home terminal 10 and the processing result may be transmitted to the server 200. For example, the feature value extraction or the like from the images may be performed on the home terminal 10 side, and the result may be transmitted to the server 200. This reduces the communication load from the home terminal 10 to the server 200 and the processing load on the server 200.

### Second Example Embodiment

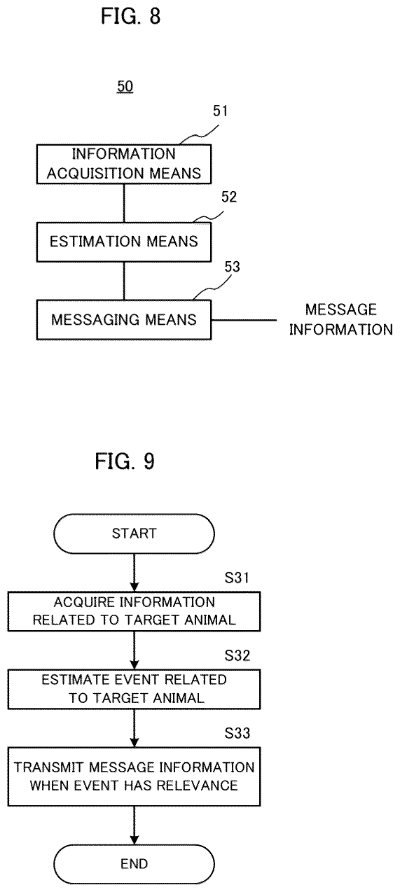

FIG. 8 is a block diagram illustrating a functional configuration of an information processing device according to a second example embodiment. The information processing device 50 according to the second example embodiment includes an information acquisition means 51, an estimation means 52 and a messaging means 53. The information acquisition means 51 acquires information related to a target animal. The estimation means 52 estimates an event related to the target animal based on the acquired information. The messaging means 53 transmits message information based on at least one of the event and relevance when the estimated event related to the target animal has the relevance.

FIG. 9 is a flowchart illustrating processing performed by the information processing device 50 according to the second example embodiment. The information acquisition means 51 acquires information related to a target animal (step S31). The estimation means 52 estimates an event related to the target animal based on the acquired information (step S32). The messaging means 53 transmits message information based on at least one of the event and relevance when the estimated event related to the target animal has the relevance (step S33).

According to the information processing device 50 of the second example embodiment, it is possible to transmit the message information based on the event estimated for the target animal or the relevance of the event.

A part or all of the example embodiments described above may also be described as the following supplementary notes, but not limited thereto.

(Supplementary note 1)

An information processing device comprising:
an information acquisition means configured to acquire information related to a target animal;
an estimation means configured to estimate an event related to the target animal based on the acquired information; and
a messaging means configured to transmit message information based on at least one of the event and relevance when the estimated event related to the target animal has the relevance.

(Supplementary note 2)

The information processing device according to Supplementary note 1, wherein the relevance includes that a same event occurred for a plurality of target animals at a same time or within a predetermined time.

(Supplementary note 3)

The information processing device according to Supplementary note 2, wherein the messaging means transmits the message information indicating that the same event occurred simultaneously or synchronously when the same event occurred for the plurality of target animals at the same time or within the predetermined time.

(Supplementary note 4)

The information processing device according to Supplementary note 2 or 3, wherein the relevance includes that the same event occurred for the plurality of target animals in such a manner that one follows another in time.

(Supplementary note 5)

The information processing device according to any one of Supplementary notes 1 to 4, wherein the relevance includes that a plurality of events occurred in a same order for a plurality of target animals.

(Supplementary note 6)

The information processing device according to any one of Supplementary notes 1 to 5, wherein the messaging means transmits additional information related to the event.

(Supplementary note 7)

The information processing device according to Supplementary note 6, wherein the additional information includes at least one of advertising information, discount information, and presentation information of a product related to the event.

(Supplementary note 8)

The information processing device according to Supplementary note 6 or 7,
wherein the relevance includes occurrence of the same event at a same time or within a predetermined time for a plurality of target animals, and
wherein the messaging means transmits additional information according to a number of the target animals for which the same event occurred at the same time or within a predetermined time.

(Supplementary note 9)

The information processing device according to Supplementary note 8, wherein the messaging means transmits the additional information with high value when a rare event occurs.

(Supplementary note 10)

The information processing device according to Supplementary note 8, wherein the messaging means transmits the additional information having higher value as a number of the target animals for which the same event occurred at a same time or within a predetermined time is larger.

(Supplementary note 11)

The information processing device according to any one of Supplementary notes 6 to 10, wherein the messaging means transmits the additional information as an animal corresponding to a company or an advertiser.

(Supplementary note 12)

An information processing method comprising:
acquiring information related to a target animal;
estimating an event related to the target animal based on the acquired information; and
transmitting message information based on at least one of the event and relevance when the estimated event related to the target animal has the relevance.

(Supplementary note 13)

A recording medium recording a program, the program causing a computer to execute processing comprising:
acquiring information related to a target animal;
estimating an event related to the target animal based on the acquired information; and
transmitting message information based on at least one of the event and relevance when the estimated event related to the target animal has the relevance.

While the present invention has been described with reference to the example embodiments and examples, the present invention is not limited to the above example embodiments and examples. Various changes which can be understood by those skilled in the art within the scope of the present invention can be made in the configuration and details of the present invention.

### DESCRIPTION OF SYMBOLS

10 Home terminal
15 Fixed camera
16 Microphone
17 Automatic feeder
18 Pet toilet
19 Speaker
20 Pet terminal
24 Pet camera
27 Biological sensor
100 Home system
200 Server
300 User terminal

What is claimed is:

1. An information processing device comprising:
a memory configured to store instructions; and
one or more processors configured to execute the instructions to:
acquire information related to a target animal;
estimate an event related to the target animal based on the acquired information; and
transmit message information based on at least one of the event and relevance when the estimated event related to the target animal has the relevance.

2. The information processing device according to claim 1, wherein the relevance includes that a same event occurred for a plurality of target animals at a same time or within a predetermined time.

3. The information processing device according to claim 2, wherein the one or more processors transmit the message information indicating that the same event occurred simultaneously or synchronously when the same event occurred for the plurality of target animals at the same time or within the predetermined time.

4. The information processing device according to claim 2, wherein the relevance includes that the same event occurred for the plurality of target animals in such a manner that one follows another in time.

5. The information processing device according to claim 1, wherein the relevance includes that a plurality of events occurred in a same order for a plurality of target animals.

6. The information processing device according to claim 1, wherein the one or more processors transmit additional information related to the event.

7. The information processing device according to claim 6, wherein the additional information includes at least one of advertising information, discount information, and presentation information of a product related to the event.

8. The information processing device according to claim 6,
wherein the relevance includes occurrence of the same event at a same time or within a predetermined time for a plurality of target animals, and
wherein the one or more processors transmit additional information according to a number of the target animals for which the same event occurred at the same time or within a predetermined time.

9. The information processing device according to claim 8, wherein the one or more processors transmit the additional information with high value when a rare event occurs.

10. The information processing device according to claim 8, wherein the one or more processors transmit the additional information having higher value as a number of the target animals for which the same event occurred at a same time or within a predetermined time is larger.

11. The information processing device according to claim 6, wherein the one or more processors transmit the additional information as an animal corresponding to a company or an advertiser.

12. An information processing method comprising:
acquiring information related to a target animal;
estimating an event related to the target animal based on the acquired information; and
transmitting message information based on at least one of the event and relevance when the estimated event related to the target animal has the relevance.

13. A non-transitory computer-readable recording medium recording a program, the program causing a computer to execute processing comprising:
acquiring information related to a target animal;
estimating an event related to the target animal based on the acquired information; and
transmitting message information based on at least one of the event and relevance when the estimated event related to the target animal has the relevance.
